(19) United States
(12) Patent Application Publication
(10) Pub. No.: US 2025/0197213 A1
(43) Pub. Date: Jun. 19, 2025

(54) OPERATION METHOD AND OPERATION SYSTEM FOR SIMULTANEOUS PRODUCTION OF HIGH-PURITY HYDROGEN AND SYNTHESIS GAS

(71) Applicant: KOREA INSTITUTE OF ENERGY RESEARCH, Daejeon (KR)

(72) Inventors: Hyung Jin YOON, Daejeon (KR); Sang Sup HAN, Daejeon (KR); Jong Kee PARK, Daejeon (KR); Hee Tae BEUM, Daejeon (KR); Shin Wook KANG, Daejeon (KR); Ji Chan PARK, Daejeon (KR); Jong Ho PARK, Daejeon (KR); Young Hwan CHU, Sejong-si (KR)

(73) Assignee: KOREA INSTITUTE OF ENERGY RESEARCH, Daejeon (KR)

(21) Appl. No.: 19/007,328

(22) Filed: Dec. 31, 2024

(30) Foreign Application Priority Data
Nov. 1, 2023 (KR) 10-2023-0149133

(51) Int. Cl. C01B 3/38; C01B 3/50

(52) U.S. Cl. CPC C01B 3/382; C01B 3/508; C01B 2203/0233; C01B 2203/0238; C01B 2203/0261; C01B 2203/0425; C01B 2203/0475; C01B 2203/1241; C01B 2203/1614; C01B 2203/1628

(57) ABSTRACT

Various examples of the present invention relate to an operation method for simultaneous production of high-purity hydrogen and synthesis gas, comprising a first operation mode of sorption-enhanced steam methane reforming; and a second operation mode of methane dry reforming, in which operation is performed by switching between the first operation mode and the second operation mode. Various examples of the present invention relate to an operation system for simultaneous production of high-purity hydrogen and synthesis gas, comprising a first operation mode of sorption-enhanced steam methane reforming; and a second operation mode of methane dry reforming, in which operation is performed by switching between the first operation mode and the second operation mode.

### BACKGROUND OF THE INVENTION

### Field of the Invention

Various examples of the present invention relate to an operation method and an operation system for simultaneous production of high-purity hydrogen and synthesis gas. Specifically, various examples of the present invention relate to an operation method and an operation system for simultaneous production of high-purity hydrogen and synthesis gas, which prevent carbon deposition (coke formation) and enable stable continuous operation.

### Description of the Related Art

The need for reducing greenhouse gas emissions has been continuously increasing due to climate change caused by global warming. Accordingly, hydrogen, a clean energy source that does not contain carbon, has been attracting significant attention. When extracted hydrogen is produced from natural gas through conventional steam reforming, 8 g-CO₂/1 kg-H₂ is emitted. In order to activate the hydrogen economy, the eco-friendliness of extracted hydrogen is required to be improved, and to this end, it is important to reduce the amount of CO₂ generated during hydrogen production. CO₂ emissions can be reduced by capturing and disposing of CO₂ generated during the extracted hydrogen production process or recycling the CO₂, but this incurs additional costs. Therefore, in order to improve the eco-friendliness of extracted hydrogen without compromising the economic feasibility of extracted hydrogen, it is important to reduce additional equipment investment costs due to reduced CO₂ emissions and reduce operation costs through improved production efficiency.

### SUMMARY OF THE INVENTION

The present invention has been made in consideration of the above problems, and an object thereof is to provide a continuous reaction process system capable of simultaneously producing high-purity hydrogen and synthesis gas, respectively, through switching operation of sorption-enhanced steam methane reforming and methane dry reforming.

Various examples of the present invention relate to an operation method for simultaneous production of high-purity hydrogen and synthesis gas, comprising a first operation mode of sorption-enhanced steam methane reforming; and a second operation mode of methane dry reforming, in which operation is performed by switching between the first operation mode and the second operation mode.

Various examples of the present invention relate to an operation system for simultaneous production of high-purity hydrogen and synthesis gas, comprising a first operation mode of sorption-enhanced steam methane reforming; and a second operation mode of methane dry reforming, in which operation is performed by switching between the first operation mode and the second operation mode.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of operation methods according to various examples of the present invention;

FIG. 2 is a drawing for explaining operation methods according to various examples of the present invention;

FIG. 3 illustrates the results of a continuous experiment of SE-SMR/MDR conducted by the operation method according to Comparative Example 1;

FIG. 4 illustrates the results of a continuous experiment of SE-SMR/MDR conducted by the operation method according to Example 1;

FIG. 5 is a TEM image of the catalyst after the reaction according to Comparative Example 1;

FIG. 6 is a TEM image of the catalyst after the reaction according to Example 1; and

FIG. 7 illustrates the results of carbon balance for comparing the degree of carbon deposition.

### DETAILED DESCRIPTION OF THE PREFERRED EMBODIMENTS

Hereinafter, various examples of this document are described with reference to the attached drawings. It should be understood that examples and terms used herein are not intended to limit the technology described in this document to a particular embodiment, but rather to encompass various modifications, equivalents, and/or alternatives of the examples.

Various examples of the present invention relate to an operation method for simultaneous production of high-purity hydrogen and synthesis gas, comprising a first operation mode of sorption-enhanced steam methane reforming; and a second operation mode of methane dry reforming, in which operation is performed by switching between the first operation mode and the second operation mode.

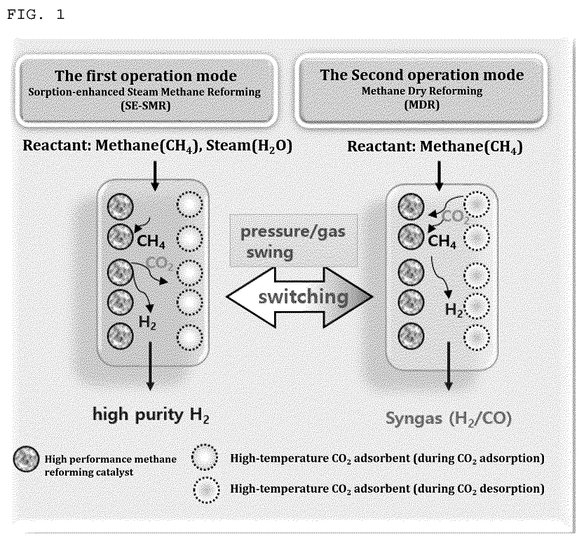

Specifically, referring to FIG. 1, a sorption-enhanced steam methane reforming (SE-SMR) reaction may be carried out in the first operation mode. Here, methane (CH₄) and steam (H₂O) are introduced as reactants, and high-purity hydrogen may be produced through the reaction with a high-performance methane reforming catalyst and a high-temperature CO₂ adsorbent. The carbon dioxide adsorbent may perform the reaction to sorb carbon dioxide in the first operation mode.

The high-performance methane reforming catalyst may include any one or two or more selected from the group consisting of Ni, Ce, ZrO₂, MgO, Cr, γ-Al₂O₃, and Ni/Cs—CeO₂—Al₂O₃(catalyst in which Ni is supported on a Cs—CeO₂—Al₂O₃ support).

Meanwhile, the high-temperature CO₂ adsorbent may include any one or two or more selected from the group consisting of calcium oxide (CaO), magnesium oxide (MgO), zirconium oxide (ZrO₂), aluminum oxide (Al₂O₃), dolomite (CaO—MgO), a carbonate of an alkali metal, and a nitrate of an alkali metal. Preferably, the high-temperature CO₂ adsorbent may be a adsorbent (CaO—Al₂O₃) in which Al₂O₃ is added to CaO.

In this configuration, the first operation mode may be performed within a temperature range of 700° C. to 800° C. The first operation mode may be performed within a pressure range of 0 to 5 bar. A molar ratio of steam to CH₄ in the first operation mode may be between 3 and 5.

The detailed reaction process in the first operation mode is as follows.
1. Reforming
   CH₄ (g)+H₂O (g)→CO (g)+3H₂ (g)
      ΔH°_{reform}=+205.6 kJ/mol
2. Water gas shift
   CO (g)+H₂O (g)→CO₂ (g)+H₂ (g)
      ΔH°_{shift}=−41.1 kJ/mol
3. Carbonation
   CaO (s)+CO₂ (g)→CaCO₃ (s)
      ΔH°_{CaO}=−178.3 kJ/mol
4. SE-SMR (Total)
   CaO (s)+CH₄ (g)+2H₂O (g)→CaCO₃ (s)+4H₂ (g)
      ΔH°_{regen}=−13.3 kJ/mol

Meanwhile, a methane dry reforming reaction may be carried out in the second operation mode. Here, methane (CH₄) is introduced as a reactant, and high-purity hydrogen may be produced through the reaction with a high-performance methane reforming catalyst and a high-temperature CO₂ adsorbent. The carbon dioxide adsorbent may perform the reaction to desorb carbon dioxide in the second operation mode.

A weak oxidizer may be additionally introduced during the second operation mode. The weak oxidizer may be at least any one selected from the group consisting of oxygen (O₂), carbon dioxide (CO₂), and water vapor (H₂O). A molar ratio of weak oxidizer to methane may be between 0.1 and 1. Carbon deposition can be prevented at this molar ratio.

In this configuration, the second operation mode may be performed within a temperature range of 700° C. to 800° C. The second operation mode may be performed at a pressure of 0 bar.

The detailed reaction process in the second operation mode is as follows.
CH₄ (g)+CO₂ (g)→2CO+2H₂
   ΔH₂₉₈⁰=248 kJ/mol
3CH₄ (g)+CO₂ (g)+2H₂O→4CO+8H₂

In the operation method of the present invention, high-purity hydrogen is produced by a sorption-enhanced steam methane reforming (SE-SMR) reaction, and the reaction temperature can be lowered to reduce reaction energy consumption. CO₂ generated by SE-SMR can be sorbed in-situ and then reduced to CO through a methane dry reforming (MDR) reaction, thereby reducing CO₂ emissions. Further, high-purity hydrogen can be produced without an additional water gas shift (WGS) device, and the costs for downstream pressure swing adsorption (PSA) miniaturization and device investment can be reduced.

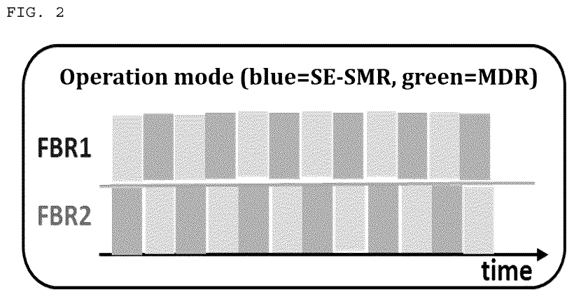

In this configuration, both the first operation mode and the second operation mode may be performed in two different streams. For example, referring to FIG. 2, two fixed bed reactors (FBRs), FBR1 and FBR2, are equipped, and the first operation mode (SE-SMR) and the second operation mode (MDR) may be alternately performed in FBR1 and FBR2, respectively. In other words, after the first operation mode (SE-SMR) is conducted in the same reactor, the second operation mode (MDR) may be performed by cycle switching.

In the first operation mode and the second operation mode, each process can proceed simply by changing the atmosphere gas in the reactor, and rapid process cycle switching is possible because no step for recovering the carbon dioxide adsorbent is involved.

Meanwhile, the operation system for simultaneous production of high-purity hydrogen and synthesis gas according to various examples of the present invention can be driven by the aforementioned operation method.

Hereinafter, the present invention will be described in detail through specific examples.

However, the following examples are only intended to illustrate the present invention, and the present invention is not limited to the following examples.

### Comparative Example 1

To examine the effect achieved by the addition of a weak oxidizer during the MDR reaction, which is the second operation mode, a continuous experiment of SE-SMR/MDR was conducted.

First, a continuous experiment of SE-SMR/MDR was conducted without adding a weak oxidizer during the MDR reaction.

Here, 10 g of Ni/Cs—CeO₂—Al₂O₃ catalyst (catalyst in which Ni is supported on a Cs—CeO₂—Al₂O₃ support) was used as a methane reforming catalyst, and 20 g of CaO—Al₂O₃ was used as a carbon dioxide adsorbent. The SE-SMR and MDR reaction conditions are as follows, respectively.

SE-SMR reaction conditions: 700° C., 7 bar, steam to CH₄ ratio (SCR) 5, space velocity (based on catalyst)=1.5 L·g_{cat}⁻¹·h⁻¹

MDR reaction conditions: 700° C., 1 bar, space velocity (based on catalyst)=0.36 L·g_{cat}⁻¹·h⁻¹

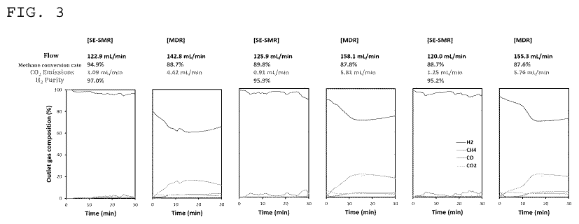

Three cycles were carried out according to the SE-SMR and MDR reaction conditions, and the results are as illustrated in FIG. 3. Referring to FIG. 3, the average production rate of high-purity hydrogen during the SE-SMR reaction was 0.118 L/min, and the hydrogen purity was at the level of 95%.

In particular, the reduction rate of CO₂ generated from raw materials for each cycle was calculated according to the following formula.

$$( 1 - \frac{mol {CO}_{2} , output}{mol {CH}_{4} , input} ) \times 100 \%$$

As a result, the reduction rate of CO₂ generated was 92.9% in the first cycle, 91.5% in the second cycle, and 91.0% in the third cycle. In other words, it can be observed that the reduction rate of CO₂ generated decreases as the cycle is repeated. This is because the catalyst is deactivated by carbon deposition (coking).

### Example 1

Meanwhile, a continuous experiment of SE-SMR/MDR was conducted under the same SE-SMR reaction conditions as those described above, and the following reaction conditions in which a small amount of steam was added during the MDR reaction.

MDR reaction conditions: 700° C., 1 bar, steam to CH₄ ratio (SCR) 0.1, space velocity (based on catalyst)=0.4 L·g_{cat}⁻¹·h⁻¹

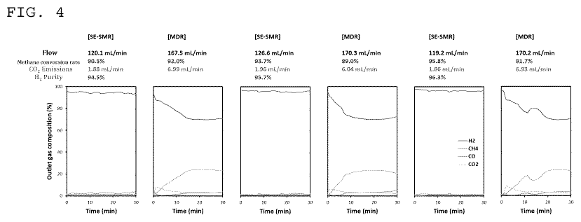

Three cycles were carried out according to the SE-SMR and MDR reaction conditions, and the results are as illustrated in FIG. 4. Referring to FIG. 4, the average production rate of high-purity hydrogen during the SE-SMR reaction was 0.121 L/min, and the hydrogen purity was at the level of 95%.

In addition, the reduction rate of CO₂ generated from raw materials for each cycle was calculated according to the aforementioned formula.

As a result, the reduction rate of CO₂ generated was 88.8% in the first cycle, 89.9% in the second cycle, and 88.9% in the third cycle. In other words, it can be observed that the reduction rate of CO₂ generated remains nearly constant by the addition of a small amount of steam during the MDR reaction.

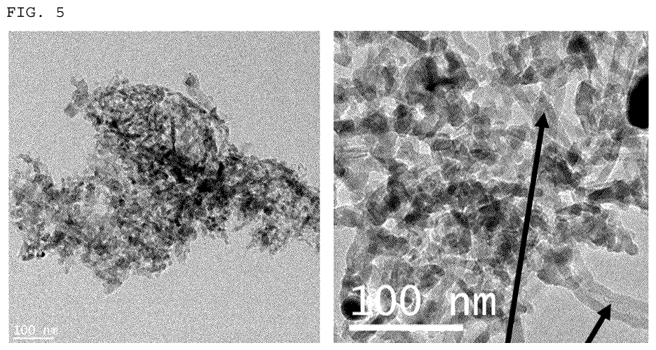

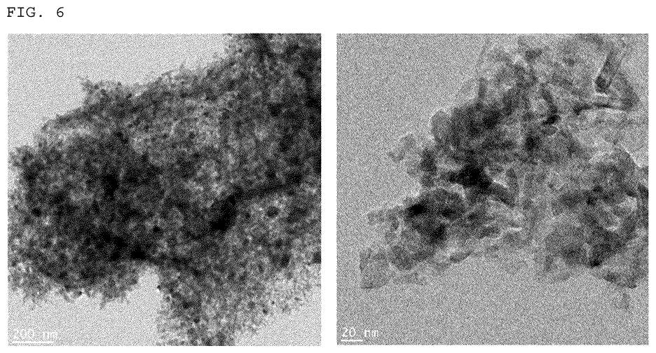

Meanwhile, TEM images of the catalysts after the reactions according to Comparative Example 1 and Example 1 were examined. FIG. 5 is a TEM image of the catalyst after the reaction according to Comparative Example 1, and FIG. 6 is a TEM image of the catalyst after the reaction according to Example 1. Referring to FIG. 5, as indicated by the arrows, some carbon whiskers were found in the catalyst at the upper part of the reactor. However, referring to FIG. 6, it can be observed that deposited carbon is not found when a small amount of steam is added.

### Example 2

To examine the effect of the weak oxidizer introduction ratio during the MDR reaction, which is the second operation mode, a continuous experiment of SE-SMR/MDR was conducted.

Here, the SE-SMR and MDR reaction conditions are as follows, respectively.

SE-SMR reaction conditions: 750° C., 4 bar, steam to CH₄ ratio (SCR) 5, space velocity (based on catalyst)=1.5 L·g_{cat}⁻¹·h⁻¹

MDR reaction conditions: 750° C., 0 bar, space velocity (based on catalyst)=0.36 L·g_{cat}⁻¹·h⁻¹

Meanwhile, the experiment was conducted by varying the molar ratio of steam to raw material methane from 0 to 1 during the MDR reaction.

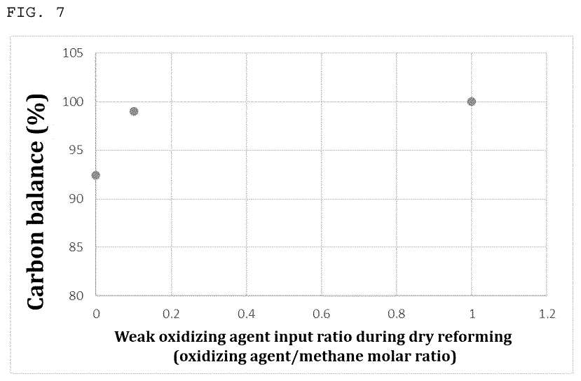

FIG. 7 illustrates the results of carbon balance for comparing the degree of carbon deposition. Referring to FIG. 7, when a weak oxidizer was not introduced at all during the MDR reaction (introduction ratio 0), about 8% of the carbon component introduced as a raw material was deposited in the form of coke. In contrast, it can be observed that carbon deposition can be prevented when the weak oxidizer introduction ratio is set between 0.1 and 1.

The features, structures, effects, and the like described in the aforementioned examples are included in at least one example of the present invention, and are not necessarily limited to a single example. Furthermore, the features, structures, effects, and the like exemplified in each example can be combined or modified and implemented in other examples by those skilled in the art to which the examples pertain. Therefore, the contents related to such combinations and modifications should be interpreted as being included within the scope of the present invention.

In addition, although the present invention has been described focusing on the examples, these are for merely illustrative purposes and do not limit the present invention, and those skilled in the art to which the present invention pertains will recognize that various modifications and applications not exemplified above are possible without departing from the essential characteristics of the present examples. For example, each component specifically shown in the examples can be modified and implemented. Additionally, the differences related to such modifications and applications should be construed as being included within the scope of the present invention defined in the appended claims.

The operation method and operation system of the present invention can simultaneously produce high-purity hydrogen and synthesis gas, respectively, through switching operation of sorption-enhanced steam methane reforming and methane dry reforming. In addition, catalyst deactivation caused by carbon deposition (coke formation) is prevented, and formation of pressure gradient within the reaction tower is prevented, thereby enabling stable continuous operation.

In the operation method of the present invention, high-purity hydrogen is produced by a sorption-enhanced steam methane reforming (SE-SMR) reaction, and the reaction temperature can be lowered to reduce reaction energy consumption. CO₂ generated by SE-SMR can be sorbed in-situ and then reduced to CO through a methane dry reforming (MDR) reaction, thereby reducing CO₂ emissions. Further, high-purity hydrogen can be produced without an additional water gas shift (WGS) device, and the costs for downstream pressure swing adsorption (PSA) miniaturization and device investment can be reduced.

While the present invention has been described with respect to the specific embodiments, it will be apparent to those skilled in the art that various changes and modifications may be made without departing from the spirit and scope of the invention as defined in the following claims.

This patent was supported by the Research and development program of the National Research Foundation of Korea (NRF-2022M3J2A1085659) and Korea Institute of Energy Research (C4-2403).

What is claimed is:

1. An operation method for simultaneous production of high-purity hydrogen and synthesis gas, comprising:
a first operation mode of sorption-enhanced steam methane reforming;
a second operation mode of methane dry reforming, wherein
operation is performed by switching between the first operation mode and the second operation mode.

2. The operation method according to claim 1, wherein
high-purity hydrogen is produced in the first operation mode, and
hydrogen and synthesis gas are produced in the second operation mode.

3. The operation method according to claim 1, wherein
a carbon dioxide adsorbent sorbs carbon dioxide in the first operation mode, and
a carbon dioxide adsorbent desorbs carbon dioxide in the second operation mode.

4. The operation method according to claim 1, wherein
a weak oxidizer is introduced during the second operation mode.

5. The operation method according to claim 4, wherein
the weak oxidizer is at least any one selected from the group consisting of oxygen (O₂), carbon dioxide (CO₂), and water vapor (H₂O).

6. The operation method according to claim 4, wherein
a molar ratio of the weak oxidizer to methane is between 0.1 and 1.

7. The operation method according to claim 1, wherein
the first operation mode is performed within a temperature range of 700° C. to 800° C.

8. The operation method according to claim 1, wherein
the first operation mode is performed within a pressure range of 0 to 5 bar.

9. The operation method according to claim 1, wherein
a molar ratio of steam to CH₄ in the first operation mode is between 3 and 5.

10. An operation system for simultaneous production of high-purity hydrogen and synthesis gas, comprising:
a first operation mode of sorption-enhanced steam methane reforming;
a second operation mode of methane dry reforming, wherein
operation is performed by switching between the first operation mode and the second operation mode.

11. The operation system according to claim 10, wherein
high-purity hydrogen is produced in the first operation mode, and
hydrogen and synthesis gas are produced in the second operation mode.

12. The operation system according to claim 10, wherein
a carbon dioxide adsorbent sorbs carbon dioxide in the first operation mode, and
a carbon dioxide adsorbent desorbs carbon dioxide in the second operation mode.

13. The operation system according to claim 10, wherein
a weak oxidizer is introduced during the second operation mode.

14. The operation system according to claim 13, wherein
the weak oxidizer is at least any one selected from the group consisting of oxygen (O₂),

15. The operation system according to claim 13, wherein
a molar ratio of the weak oxidizer to methane is between 0.1 and 1.
